(19) United States
(12) Patent Application Publication
(10) Pub. No.: US 2026/0358781 A1
(43) Pub. Date: Nov. 12, 2026

(54) THERMAL DISPLACEMENT CORRECTION DEVICE FOR MACHINE TOOL

(71) Applicants: CITIZEN WATCH CO., LTD., Tokyo (JP); CITIZEN MACHINERY CO., LTD., Nagano (JP)

(72) Inventor: Kazuhiro HOTTA, Nagano (JP)

(21) Appl. No.: 19/139,299

(22) PCT Filed: Sep. 8, 2023
(86) PCT No.: PCT/JP2023/032831

§ 371 Date: Jun. 13, 2025

(30) Foreign Application Priority Data
Dec. 19, 2022 (JP) 2022-202074

(51) Int. Cl. B23Q 17/00

(52) U.S. Cl. CPC B23Q 17/007

(57) ABSTRACT

A thermal displacement correction device for a machine tool includes a temperature sensor provided in each of a plurality of portions of a machine tool, a memory configured to store a plurality of correspondence relationships for each of a plurality of environmental conditions as a correspondence relationship between a temperature distribution of the machine tool and a thermal displacement amount of a position of the tool, a comparison selection portion configured to compare the temperature distribution of the machine tool when the machine tool machines under an environmental condition with the temperature distribution of the machine tool, and select one of a plurality correspondence relationships that is closest to the temperature distribution of the machine tool, a thermal displacement estimation portion configured to estimate the thermal displacement amount and the temperature distribution of the machine tool, and a correction command portion configured to cancel the thermal displacement amount.

### CROSS-REFERENCE TO RELATED APPLICATIONS

This application is a national phase of International Application No. PCT/JP2003/032831 filed on Sep. 8, 2023, and claims priority to Japanese Patent Application No. 2022-202074 filed with the Japan Patent Office on Dec. 19, 2022, the entire disclosures of which are incorporated herein by reference.

### TECHNICAL FIELD

The present disclosure relates to a thermal displacement correction device for a machine tool.

A machine tool generates heat in a driving source and a sliding portion, etc., by operating the driving source to displace, for example, to rotate and to move a workpiece and a tool. In addition, the machine tool also generates heat at the contact point between the workpiece and the tool. This heat displaces various portions of the machine tool due to thermal expansion, etc., which changes the position of the tool relative to the workpiece and affects the dimensional accuracy of the product obtained by machining the workpiece.

Therefore, the machine tool includes a thermal displacement correction device that suppresses the effects of the displacement due to the heat. The thermal displacement correction device includes a temperature sensor provided in various portions of the machine tool, a thermal displacement estimation portion that estimates the displacement amount of the position of the tool relative to the workpiece based on a temperature detected by each temperature sensor, and a correction command portion that outputs a correction command to a control portion of the machine tool to correct the position of the tool to cancel the displacement amount estimated by the thermal displacement portion.

The thermal displacement estimation portion stores the correspondence relationship between the detected temperature Ti (i=1, 2, 3, . . . ) and the measured displacement amount (thermal displacement amount) ΔA of the positions of the workpiece and the tool as the following multiple regression equation (1). The detected temperature Ti is detected by each temperature sensor under each machining condition when a workpiece is previously machined under various machining conditions (e.g., condition regarding machining step such as cutting amount, rotation speed of workpiece, and feeding speed of tool).

ΔA=α1*T1+α2*T2+α3*T3+ (1)

In the equation (1), αi (i=1, 2, 3, . . . ) is a coefficient (thermal displacement coefficient) corresponding to the detected temperature Ti by each temperature sensor, and is preset to satisfy the equation (1) for various machining conditions. The thermal displacement estimation portion estimates the thermal displacement amount ΔA based on the detected temperature Ti detected by each temperature sensor when the machine tool is actually used to manufacture a product and the stored equation (1). The output portion of the thermal displacement correction device outputs the correction command, to the control portion of the machine tool, to correct the thermal displacement estimated by the thermal displacement estimate portion to cancel the thermal displacement amount. The control portion of the machine tool controls the position of the tool relative to the workpiece to perform the correction that cancels the thermal displacement amount based on the correction command output from the correction command portion of the thermal displacement correction device, thereby reducing the effects of the thermal displacement on the dimensional accuracy of the product obtained by machining with the machine tool (see e.g., Patent Document 1: Japanese Patent Application Publication No. 2004-154907A).

### SUMMARY

Meanwhile, the thermal displacement coefficient αi in the equation (1) stored in the thermal displacement estimation portion of the thermal displacement correction device is set when the machine tool is placed in a predetermined reference environment. On the other hand, as the machine tool is installed and used at a site where a product is actually manufactured, the environment in which the machine tool is installed varies greatly and may differ from the predetermined reference environment.

Therefore, to manufacture a product with higher dimensional accuracy in an environment in which a machine tool is installed, it is necessary to improve the correction accuracy of the machine tool relative to the thermal displacement.

The present disclosure has been made in view of the above circumstances and aims to provide a thermal displacement correction device for a machine tool that can improve the correction accuracy relative to the thermal displacement.

The present disclosure relates to a thermal displacement correction device for a machine tool, including: a temperature sensor provided in each of a plurality of portions of a machine tool; a memory configured to store a plurality of correspondence relationships set for each of a plurality of environmental conditions, which are different from each other, as a correspondence relationship between a temperature distribution of the machine tool detected by the temperature sensor corresponding to machining under a previously set predetermined machining condition and a thermal displacement amount of a position of the tool relative to a workpiece machined by the tool of the machine tool; a comparison selection portion configured to compare the temperature distribution of the machine tool detected by the temperature sensor when the machine tool machines under an environmental condition in which the machine tool is installed with the temperature distribution of the machine tool in a plurality of correspondence relationships stored in the memory, and select one of a plurality of correspondence relationships stored in the memory that is closest to the temperature distribution of the machine tool detected under the environmental condition in which the machine tool is installed; a thermal displacement estimation portion configured to estimate the thermal displacement amount under the environmental condition in which the machine tool is installed based on the one correspondence relationship selected by the comparison selection portion and the temperature distribution of the machine tool detected under the environmental condition in which the machine tool is installed; and a correction command portion configured to output a thermal displacement correction amount to correct the position of the tool to cancel the thermal displacement amount estimated by the thermal displacement estimation portion.

### BRIEF DESCRIPTION OF DRAWINGS

FIG. 1 is a block diagram illustrating a configuration of a thermal displacement correction device.

FIG. 2 is a perspective view illustrating an automatic lathe in which thermal displacement is corrected by the thermal displacement correction device.

FIG. 3 is an example illustrating a relationship between an elapsed time t and a temperature Ti of each portion under a first machining condition K1 shown in Table 1.

FIG. 4 is a flowchart describing a flow of an operation of the thermal displacement correction device.

### DETAILED DESCRIPTION

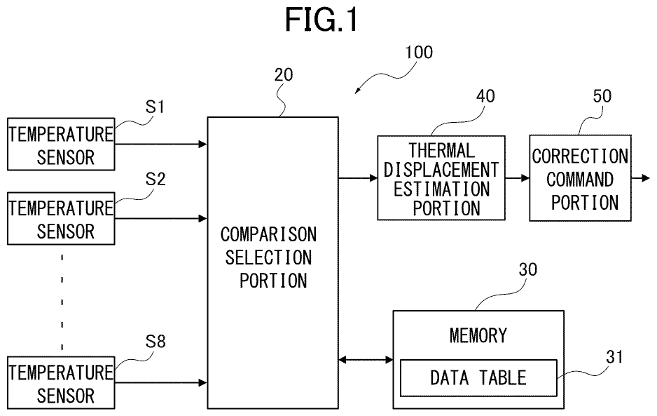

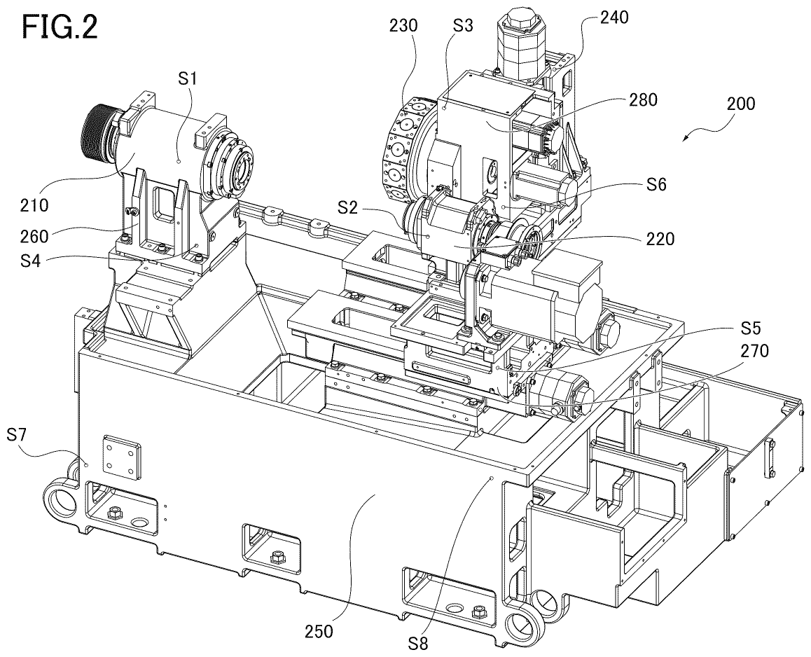

An embodiment of a thermal displacement correction device for a machine tool according to the present disclosure is described below with reference to the drawings.

<Configuration> FIG. 1 is a block diagram illustrating a configuration of a thermal displacement correction device 100, and FIG. 2 is a perspective view illustrating an automatic lathe 200 in which thermal displacement is corrected by the thermal displacement correction device 100. The thermal displacement correction device 100 illustrated in the figures is an embodiment of a thermal displacement correction device for a machine tool according to the present disclosure, and the automatic lathe 200 is an embodiment of a machine tool to which the thermal displacement correction device for a machine tool according to the present disclosure is applied.

(Automatic lathe) The automatic lathe 200 is an NC lathe whose operation is controlled by a computer that reads a predetermined program to execute. As illustrated in FIG. 2, the automatic lathe 200 includes on a bed 250, a front main spindle 210, a rear main spindle 220, a turret tool post 230, and a control portion 240. The rear main spindle 220 is disposed to face the front main spindle 210. The front main spindle 210 and the rear main spindle 220 can each independently hold a workpiece as a machining target and rotate it about its axis, and can also transfer the workpiece to each other.

The front main spindle 210 is mounted on a spindle headstock 260 provided on the bed 250. The rear main spindle 220 is mounted on a slide base 270 provided on the bed 250.

The turret tool post 230 has a plurality of tools for machining the workpiece provided on an outer peripheral surface of a rotating turret. The turret tool post 230 selects a tool in accordance with the rotation of the turret. The automatic lathe 200 performs machining such as cutting and drilling on the workpiece by rotating the front main spindle 210 and the rear main spindle 220 about axes while bringing the selected tool on the turret tool post 230 into contact with the workpiece. The turret tool post 230 is mounted on a slide support base 280.

The control portion 240 controls the positions, the movement, and the speed of the front main spindle 210, the rear main spindle 220, the turret tool post 230, the slide base 270, and the slide support base 280 by a computer that reads a predetermined program to execute. Additionally, the control portion 240 corrects the positions of the front main spindle 210, the rear main spindle 220, the turret tool post 230, the slide base 270, and the slide support base 280 in response to a correction command output from a correction command portion 50 of the thermal displacement correction device 100 described below. The automatic lathe 200 includes a coolant system (not illustrated) that discharges coolant, and the control portion 240 also controls the operation of the coolant system.

(Thermal displacement correction device) The thermal displacement correction device 100 is provided in the automatic lathe 200. The thermal displacement correction device 100 suppresses the effect of the displacement by heat (thermal displacement) caused by the automatic lathe 200, and outputs a correction command, to the control portion 240 of the automatic lathe 200, to correct the position of the machining point to cancel the thermal displacement at the machining point (point where tool contacts workpiece) in the automatic lathe 200.

As illustrated in FIG. 1, the thermal displacement correction device 100 includes a temperature sensors Si (i=1, 2, . . . , 8), a memory 30, a comparison selection portion 20, a thermal displacement estimation portion 40, and a correction command portion 50.

As illustrated in FIG. 2, the temperature sensor Si is provided in a plurality of locations (in this embodiment, eight locations (i=1, 2, . . . , 8), for example) of the automatic lathe 200. More particularly, the temperature sensor S1 is provided in the front main spindle 210, the temperature sensor S2 is provided in the rear main spindle 220, the temperature sensor S3 is provided in the turret tool post 230, the temperature sensor S4 is provided in the spindle headstock 260, the temperature sensor S5 is provided in the slide base 270, the temperature sensor S6 is provided in the slide support base 280, the temperature sensor S7 is provided in the portion of the bed 250 that is close to the spindle headstock 260, and the temperature sensor S8 is provided in the portion of the bed 250 that is close to the slide base 270. Each temperature sensor detects the temperature at each provided location.

In the following, when the temperature sensors S1, S2, . . . , S8 are not distinguished, they are collectively referred to as a temperature sensor Si.

the comparison selection portion 20 compares the temperature distribution (thermal balance) of the automatic lathe 200 detected by the eight temperature sensors Si when the automatic lathe 200 actually operates to manufacture a product with a plurality of temperature distributions measured when the automatic lathe 200 operates a predetermined machining operation under a plurality of previously set environment conditions stored in the memory 30 described later, and selects a temperature distribution closest to the temperature distribution when the automatic lathe 200 actually operates.

The memory 30 stores the above described temperature distributions as a data table 31. More specifically, first, the automatic lathe 200 operates to machine a previously set predetermined workpiece under a plurality of previously set machining conditions Kp (p=1, 2, . . . , for example, condition regarding machining step by automatic lathe 200 such as cutting amount, rotation speed of workpiece, and feeding speed of tool) to manufacture a product having a previously set predetermined shape.

At this time, an elapsed time t [second] from the start of the machining by the automatic lathe 200 and the temperature Ti (T1, T2, . . . . T8) of each portion of the automatic lathe 200 detected by each temperature sensor Si (S1, S2, . . . , S8) when the workpiece is machined under each machining condition Kp are detected and recorded, and the thermal displacement amount ΔA of the position of the machining point where the tool on the turret tool post 230 contacts the workpiece at that time is recorded.

For example, Table 1 shows the correspondence among the elapsed time t [second], the detected temperature Ti (T1, T2, . . . , T8) at each portion, and the measured thermal displacement amount ΔA of the position of the machining point when the product is manufactured by machining the workpiece under the first machining condition K1

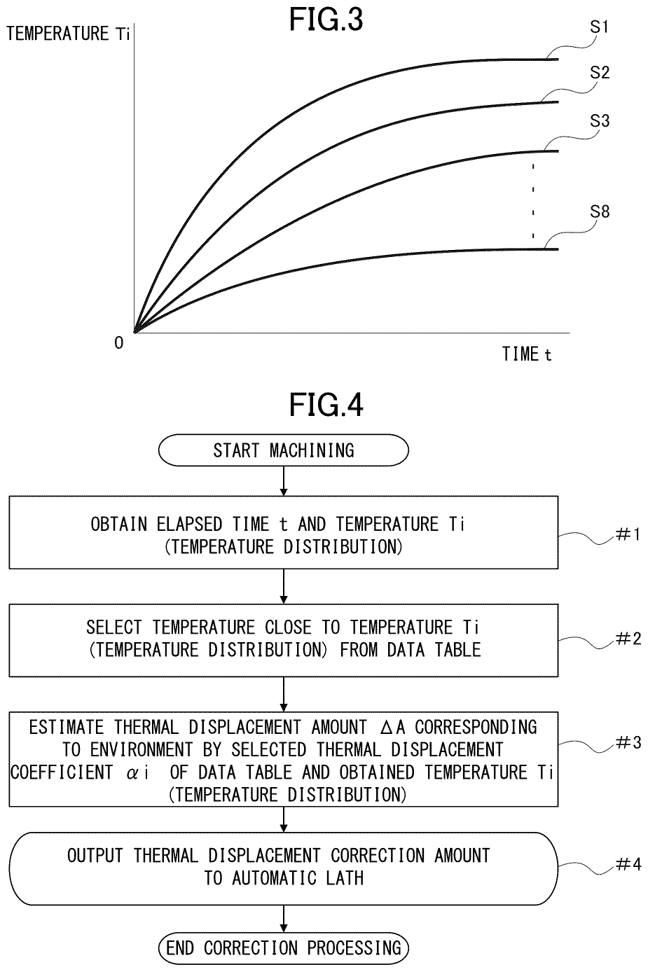

FIG. 3 is an example showing the correspondence relationship between the elapsed time t and the temperature Ti of each portion under the first machining condition K1 shown in Table 1. The elapsed time t and the temperature Ti of each portion under the first machining condition K1 described above are as shown in FIG. 3, for example. Note that FIG. 3 is a schematic diagram for simply describing the relationship between the elapsed time t and the temperature Ti of each portion, and does not show the relationship between the actually measured elapsed time t and the temperature Ti of each portion.

In this way, the thermal displacement coefficient αi (i=1, 2, 3, . . . ) corresponding to the temperature sensors Si is calculated so that the thermal displacement amount ΔA of the position of the machining point and the temperature Ti (T1, T2, . . . , T8) of each portion at each elapsed time t under the first machining condition K1 satisfy the following multiple regression equation (1).

ΔA=α1*T1+α2*T2+. . . +α8*T8 (1)

As a result of the calculation, as shown in Table 2, the set (α₁, α₂, . . . , as) of the thermal displacement coefficient αi (i=1, 2, . . . , 8) of the temperature sensor Si is associated with the elapsed time t under the first machining condition K1.

Then, using the same workpiece, similar in other machining conditions Kp (second machining condition K2, third machining condition K3, . . . ), the elapsed time t [second], the detected temperature Ti (T1, T2, . . . , T8) at each portion, and the measured thermal displacement amount ΔA of the position of the machining point are associated, and the thermal displacement coefficient αi (i=1, 2, 3, . . . ) corresponding to the temperature sensor Si is calculated to satisfy the multiple regression equation (1), and the elapsed time t and the sets (α1, α2, . . . , α8) of the thermal displacement coefficient αi (i=1, 2, . . . , 8) of the temperature sensor Si are then associated with the machining condition Kp, similar to Table 2.

The number of machining conditions p is, for example, ten (p=1, 2, . . . , 10) in this embodiment; however, the number of machining conditions may be one or more and nine or less, or eleven or more.

Next, the environmental condition Mq corresponding to the environment of the site where the automatic lathe 200 is installed is changed, and in a plurality of environmental conditions Mq, the temperature Ti and the thermal displacement amount ΔA are measured at each elapsed time t under the above described each machining condition Kp, and the set (α1, α2, . . . , α8) of the thermal displacement coefficient αi (i=1, 2, . . . , 8) of the temperature sensor Si corresponding to each environmental condition Mq for each elapsed time t under each machining condition Kp is associated.

The environmental condition Mq is a condition other than the above described machining condition Kp, which assumes the environmental of the site where the automatic lathe 200 is actually installed, and in particular, a condition that affects the thermal displacement of the position of the machining point of the tool. The environmental condition Mq specifically is a condition that may change the temperature of the automatic lathe 200 such as an ambient temperature (room temperature) of a site where the automatic lathe 200 is installed, partial sunlight, and a positional relationship with a surrounding heat source.

The number of previously set environmental conditions Mq is, for example, ten; however, the number of previously set environmental conditions may be any number of two or more, and may be nine or less or eleven or more.

In this way, before the automatic lathe 200 is actually installed in the environment where it manufactures a product, the automatic lathe 200 is experimentally installed under various anticipated environmental conditions Mq, and the correspondence relationship (Table 1 as one example) between the temperature distribution Ti of each portion and the thermal displacement amount ΔA under each environmental condition Mq in a plurality of environmental conditions Mq under each machining condition Kp obtained by machining the workpiece under the various machining conditions Kp at each elapsed time is stored in the memory as the data table 30.

Furthermore, each data table 31 also includes the correspondence relationship (Table 2 as one example) between the distribution of temperature Ti of each portion and the set of the thermal displacement coefficient αi (e.g., α1, α2, . . . , α8) under each environmental condition Mq in a plurality of environmental conditions Mq under each machining condition Kp obtained by machining the workpiece under various machining conditions Kp at each elapsed time t.

The memory 30 stores, as described above, many data tables 31 under each environmental condition Mq that assumes the site where the automatic lathe 200 is installed before the automatic lathe 200 is actually installed at the site where the product is manufactured. The comparison selection portion 20 compares, when the automatic lathe 200 is installed at a specific site and machines a workpiece for manufacturing a product, the temperature Ti (temperature distribution) of each portion of the automatic lathe 200 detected by the eight temperature sensors Si at a predetermined elapsed time t with the temperature distribution in the data table 31 of the temperature distribution.

Then, the comparison selection portion 20 selects one of the many data tables 31 stored in the memory 30 that has the temperature distribution closest to the temperature Ti (temperature distribution) actually detected from the automatic lathe 200 installed at a specific site, and outputs the data table together with the actually detected temperature Ti (temperature distribution) to the thermal displacement estimation portion 40.

The thermal displacement estimation portion 40 estimates the thermal displacement amount ΔA of the position of the machining point in the temperature distribution with the multiple regression equation (1) by using the set of the thermal displacement coefficient αi (α1, α2, . . . α8) of the data table 31 input from the comparison selection portion 20 and the temperature Ti actually detected in each portion when installed and operated at a specific site, and outputs the estimated thermal displacement amount ΔA to the correction command portion 50.

The correction command portion 50 calculates the thermal displacement correction amount to correct the position of the machining point of the tool of the automatic lathe 200 to a position that cancels the thermal displacement amount ΔA input from the thermal displacement estimation portion 40, and outputs this thermal displacement correction amount to the control portion 240 of the automatic lathe 200.

<Operation> FIG. 4 is a flowchart describing the flow of the operation of the thermal displacement correction device 100. The thermal displacement correction device 100 of this embodiment operates as follows using the flowchart in FIG. 4.

After the automatic lathe 200 is installed at a site where a product is manufactured by actually machining a workpiece with a tool, the automatic lathe 200 starts machining. The comparison selection portion 20 obtains a predetermined elapsed time t from the start of the machining by the automatic lathe 200 and the temperature Ti (temperature distribution) of each portion of the automatic lathe 200 detected by the eight temperature sensors Si provided in the automatic lathe 200 (#1).

The comparison selection portion 20 compares the temperature Ti (temperature distribution) of the automatic lathe 200 at the obtained elapsed time t with the distribution of the temperature Ti at each elapsed time t in a plurality of data tables 31 stored in the memory 30, and selects one with the closest temperature distribution (#2).

Here, “closest temperature distribution” can be defined as, for example, when the number of temperature sensors Si having the temperature Ti of the corresponding temperature sensor Si in the data table 31, which corresponds to the temperature of the approximate range of ±5%, for example, to the obtained each temperature Ti, is a predetermined set number or more.

The approximate range of the obtained each temperature Ti is not limited to the above described ±5% range; however, may also be ±10% or other preset ranges. Additionally, the number of temperature sensors Si of the approximate range when defining as “closest temperature distribution” may be appropriately set, for example, three or more, four or more, or five or more.

Furthermore, “closest temperature distribution” may, for example, be calculated by weighting in the calculation of the number for the temperature sensor Si with a large effect when the magnitude of the effect on the thermal displacement amount ΔA by the temperature Ti has an order of temperature sensors. The specific degree of the weighting may be adjusted according to the environmental condition at the site where the automatic lathe 200 is installed.

The thermal displacement estimation portion 40 estimates the thermal displacement amount ΔA when the automatic lathe 200 is actually used with the multiple regression equation (1) based on the set of thermal displacement coefficient αi (α1, α2, . . . , α8) of the data table 31 selected by the comparison selection portion 20 and the obtained temperature Ti (temperature distribution) of the automatic lathe 200 at the elapsed time (#3).

The correction command portion 50 calculates the thermal displacement correction amount to correct the position of the machining point of the tool of the automatic lathe 200 to the position that cancels the thermal displacement amount ΔA based on the thermal displacement amount ΔA estimated by the thermal displacement estimation portion 40, and outputs the calculated thermal displacement correction amount to the control portion 240 of the automatic lathe 200 (#4).

As described in detail above, the thermal displacement correction device 100 of the automatic lathe 200 of the present embodiment stores the data table 31 containing the thermal displacement coefficient αi and the temperature Ti (temperature distribution) under each of a plurality of environmental conditions assumed as the environment of the site where the automatic lathe 200 is actually installed, and corrects the thermal displacement amount at the site with the data table 31 containing the temperature Ti (temperature distribution) closest to the temperature Ti (temperature distribution) actually obtained at the installation site.

Therefore, the thermal displacement amount can be corrected to be suitable to the environment of the site where the automatic lathe 200 is installed, thereby improving the correction accuracy of the thermal displacement.

In the thermal displacement correction device 100 of this embodiment, the comparison selection portion 20 selects the data table 31 with the closest temperature distribution; however, no data table 31 with the specified closest temperature distribution may exist. Therefore, the memory 30 stores a set (αs1, αs2, . . . , αs8) of a reference thermal displacement coefficient αsi (i=1, 2, . . . , 8) set corresponding to the reference environmental condition K0 as the reference data table. Then, the comparison selection portion 20 selects this reference data table (#2).

The thermal displacement estimation portion 40 estimates thermal displacement amount ΔA when the automatic lathe 200 is actually used with the multiple regression equation (1) based on the set of reference thermal displacement coefficient αsi (αs1, αs2, . . . , αs8) of the reference data table and the temperature Ti (temperature distribution) of the automatic lathe 200 at the obtained elapsed time t (step #3). The correction command portion 50 then calculates the thermal displacement correction amount to correct the position of the machining point of the tool in the automatic lathe 200 to the position that cancels the thermal displacement amount ΔA based on the thermal displacement amount ΔA estimated by the thermal displacement estimation portion 40, and outputs the calculated thermal displacement correction amount to the control portion 240 of the automatic lathe 200 (#4).

The thermal displacement correction device 100 can correct the thermal displacement amount corresponding to the reference environmental condition by applying the set of the thermal displacement coefficient αs1, αs2, . . . , αs8 of the reference data table when there is no data table 31 with the specified closest temperature distribution. Although this correction may not always be optimal for a wide range of environmental conditions, it enables standard correction.

The thermal displacement correction device 100 of this embodiment includes the eight temperature sensors Si (i=1, 2, . . . , 8); however, the number of temperature sensors Si is not limited to eight and may be two or more, seven or less, or nine or more. Furthermore, the portion where the temperature sensor Si is provided is not limited to the portion of the automatic lathe 200 described in this embodiment, and they may be provided in other portions.

In this embodiment, the thermal displacement correction device 100 is applied to the automatic lathe 200 including the front main spindle 210, the rear main spindle 220, and the turret tool post 230 as one example of a machine tool. However, the automatic lathe 200 may have only one main spindle (front main spindle), or may have three or more main spindles, and the turret tool post 230 may be replaced with a comb shaped tool post.

In this embodiment, the thermal displacement correction device 100 is applied to the automatic lathe 200 as one example of a machine tool; however the thermal displacement correction device of the present disclosure is not limited to the application to an automatic lathe and can be applied to a machine tool other than an automatic lathe that performs various plastic processing on a workpiece.

1. A thermal displacement correction device for a machine tool, comprising:
a temperature sensor provided in each of a plurality of portions of a machine tool;
a memory configured to store a plurality of correspondence relationships set for each of a plurality of environmental conditions, which are different from each other, as a correspondence relationship between a temperature distribution of the machine tool detected by the temperature sensor corresponding to machining under a previously set predetermined machining condition and a thermal displacement amount of a position of the tool relative to a workpiece machined by the tool of the machine tool;
a comparison selection portion configured to compare the temperature distribution of the machine tool detected by the temperature sensor when the machine tool machines under an environmental condition in which the machine tool is installed with the temperature distribution of the machine tool in a plurality of correspondence relationships stored in the memory, and select one of a plurality of correspondence relationships stored in the memory that is closest to the temperature distribution of the machine tool detected under the environmental condition in which the machine tool is installed;
a thermal displacement estimation portion configured to estimate the thermal displacement amount under the environmental condition in which the machine tool is installed based on the one correspondence relationship selected by the comparison selection portion and the temperature distribution of the machine tool detected under the environmental condition in which the machine tool is installed; and
a correction command portion configured to output a thermal displacement correction amount to correct the position of the tool to cancel the thermal displacement amount estimated by the thermal displacement estimation portion.

2. The thermal displacement correction device for a machine tool according to claim 1, wherein the environmental condition is a condition that affects a temperature relative to the machine tool in an environment where the machine tool is installed.

3. The thermal displacement correction device for a machine tool according to claim 1, wherein
the memory stores a reference correspondence relationship set for a reference environmental condition as one of the plurality of correspondence relationships set for each of the plurality of environmental conditions which are different from each other, and
the comparison selection portion selects the reference correspondence relationship when there is no one correspondence relationship closest to the temperature distribution of the machine tool detected under the environmental condition in which the machine tool is installed.

4. The thermal displacement correction device for a machine tool according to claim 2, wherein
the memory stores a reference correspondence relationship set for a reference environmental condition as one of the plurality of correspondence relationships set for each of the plurality of environmental conditions which are different form each other, and
the comparison selection portion selects the reference correspondence relationship when there is no one correspondence relationship closest to the temperature distribution of the machine tool detected under the environmental condition in which the machine tool is installed.
